(19) United States
(12) Patent Application Publication
(10) Pub. No.: US 2017/0169685 A1
(43) Pub. Date: Jun. 15, 2017

(54) MARINA POWER PEDESTAL INCLUDING STRAY CURRENT PROBE

(71) Applicant: EATON CORPORATION, CLEVELAND, OH (US)

(72) Inventors: JASON DEMETRIOS EASTON, WILLIAMSBURG, VA (US); CHRIS EMMONS DRUEKE, WILLIAMSBURG, VA (US); JEFFERY SCOTT KUYKENDALL, WILLIAMSBURG, VA (US); PAUL DAVID SEFF, WILLIAMSBURG, VA (US)

(73) Assignee: EATON CORPORATION, CLEVELAND, OH (US)

(21) Appl. No.: 14/967,624

(22) Filed: Dec. 14, 2015

(51) Int. Cl. G08B 21/02; H02H 3/16

(52) U.S. Cl. CPC G08B 21/02; H02H 3/16

(57) ABSTRACT

A power pedestal structured to be attached to a platform in the vicinity of water, the power pedestal including a pedestal member including a base structured to be attached to the platform and an enclosure extending from said base. The power pedestal further includes a stray current detection unit including a stray current probe structured to extend outside the enclosure and into the water to sense a voltage in the water and a stray current detection circuit electrically connected to the stray current probe and structured to detect a stray current in the water based on the voltage sensed by the stray current probe and to output an indicator signal in response to detecting the stray current. The power pedestal also includes an indicator electrically coupled to the stray current detection unit and structured to provide an indication in response to the indicator signal.

### BACKGROUND

Field of the Invention

The disclosed concept pertains generally to power pedestals and, more particularly, to marina power pedestals.

Background Information

U.S. Pat. No. 6,844,716 discloses a utility distribution pedestal for marine and recreational vehicles.

Stray electric current is a portion of current that flows over a path other than the intended path. When power pedestals are employed in marina applications, stray currents can end up in the water in the vicinity of the power pedestal. Stray currents in marinas are extremely dangerous and have led to a number of fatalities due to electrocution or electric shock drowning (ESD). ESD is a condition where a person in the water is subjected to a paralyzing electrical shock, which in turns leads to the person drowning.

Stray currents are not visible, so if a stray current does exist in the vicinity of a power pedestal in a marina, it is likely to go undetected. Due to its lack of detection, the dangerous condition in the water will remain unfixed. Additionally, people around the marina will not be aware of the dangerous condition in the water and may not exercise due care in avoiding the water.

There is room for improvement in marina power pedestals.

### SUMMARY

These needs and others are met by embodiments of the disclosed concept wherein a power pedestal includes a stray current probe structured to detect stray current in water in the vicinity of the power pedestal.

In accordance with one aspect of the disclosed concept, a power pedestal structured to be attached to a platform in the vicinity of water comprises: a pedestal member comprising: a base structured to be attached to the platform, and an enclosure extending from said base; a stray current detection unit comprising: a stray current probe structured to extend outside the enclosure and into the water to sense a voltage in the water, and a stray current detection circuit electrically connected to the stray current probe and structured to detect a stray current in the water based on the voltage sensed by the stray current probe and to output an indicator signal in response to detecting the stray current; and an indicator electrically coupled to the stray current detection unit and structured to provide an indication in response to the indicator signal.

### BRIEF DESCRIPTION OF THE DRAWINGS

A full understanding of the invention can be gained from the following description of the preferred embodiments when read in conjunction with the accompanying drawings in which:

FIG. 1 is an isometric view of a marina power pedestal in accordance with embodiments of the disclosed concept.

FIG. 2 is a schematic diagram of the marina power pedestal of FIG. 1

FIG. 3 is an isometric view of the input power terminals of the marina power pedestal of FIG. 1.

FIG. 4 is a schematic diagram of a ground fault protection circuit in accordance with embodiments of the disclosed concept.

FIG. 5 is a view of an indicator in accordance with example embodiments of the disclosed concept.

### DESCRIPTION OF THE PREFERRED EMBODIMENTS

As employed herein, the term “vehicle” shall expressly include, but not be limited by, a land vehicle, a marine vehicle, an air vehicle or another motor vehicle.

As employed herein, the term “land vehicle” shall expressly include, but not be limited by, any land-based vehicles having pneumatic tires, any rail-based vehicles, any maglev vehicles, automobiles, cars, trucks, station wagons, sport-utility vehicles (SUVs), recreational vehicles, construction vehicles, off road vehicles, all-terrain vehicles, farm vehicles, fleet vehicles, motor homes, vans, buses, motorcycles, mopeds, campers, trailers, or bicycles.

As employed herein, the term “marine vehicle” shall expressly include, but not be limited by, any water-based vehicles, ships, boats, other vessels for travel on water, submarines, or other vessels for travel under water.

As employed herein, the term “air vehicle” shall expressly include, but not be limited by, any air-based vehicles, airplanes, jets, aircraft, airships, balloons, blimps, or dirigibles.

As employed herein, the term “number” shall mean one or an integer greater than one (i.e., a plurality).

As employed herein, the term “platform” shall mean a horizontal flat surface, a raised horizontal flat surface, or a dock pier.

As employed herein, the term “pedestal” or “pedestal member” shall mean an elongated, generally upright structure.

As employed herein, the term “power pedestal” shall mean a pedestal or pedestal member structured to input power from input power terminals (e.g., utility power terminals) and output power to a number of output power receptacles.

As employed herein, the term “fastener” refers to any suitable connecting or tightening mechanism expressly including, but not limited to, screws, bolts and the combinations of bolts and nuts (e.g., without limitation, lock nuts) and bolts, washers and nuts.

As employed herein, the statement that two or more parts are “connected” or “coupled” together shall mean that the parts are joined together either directly or joined through one or more intermediate parts. Further, as employed herein, the statement that two or more parts are “attached” shall mean that the parts are joined together directly.

The disclosed concept is described in association with a marina power pedestal, although the disclosed concept is applicable to a wide range of vehicle power pedestals.

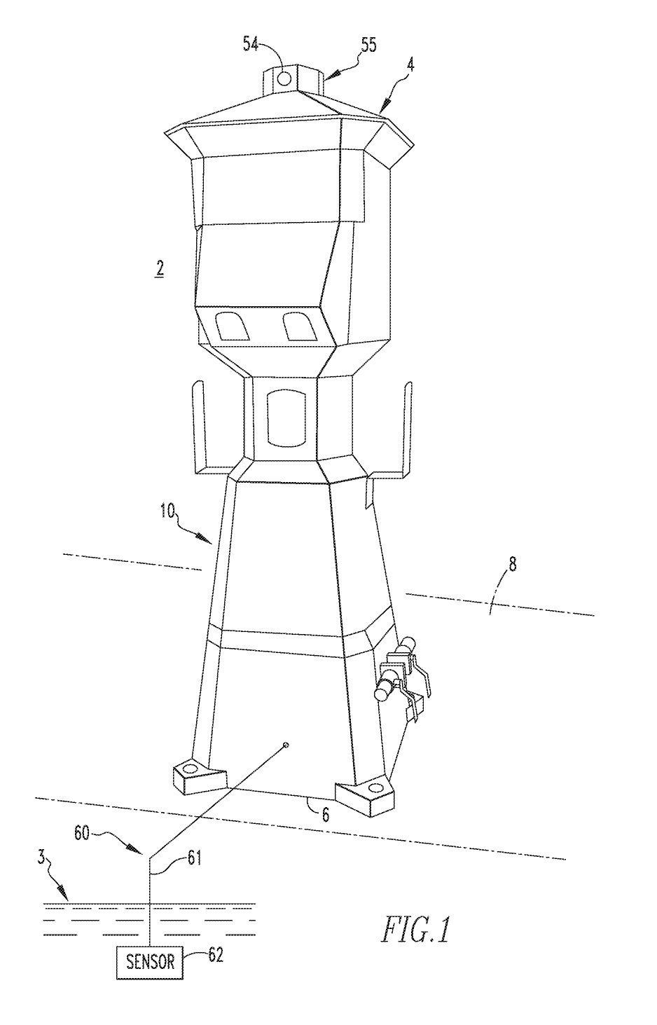

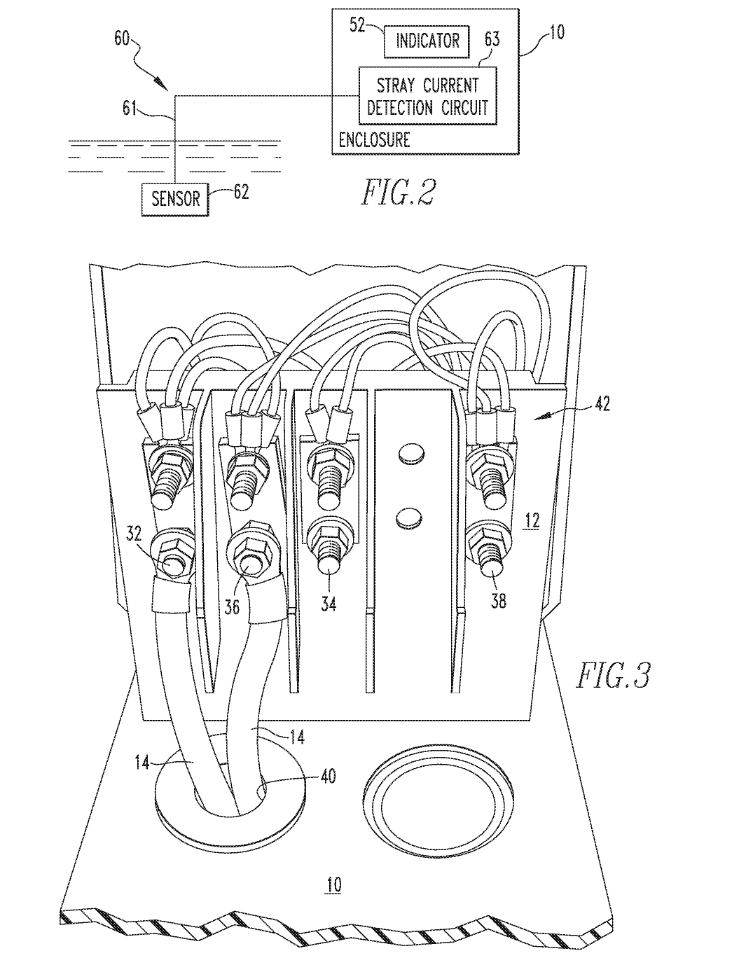

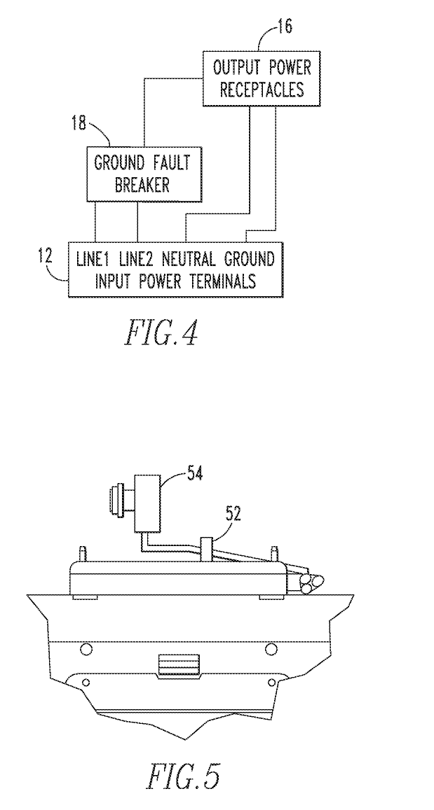

Referring to FIGS. 1 and 2, a power pedestal, such as, for example and without limitation, a marina power pedestal 2 includes a pedestal member 4 having a base 6 structured to be fixed to a platform, such as, for example and without limitation, a dock pier 8 (shown in phantom line drawing) and an enclosure 10 extending generally vertically from the base 6. A plurality of input power terminals 12 (shown in FIGS. 3 and 4) are mounted to the pedestal member 4 and are structured to be electrically connected to a power source (e.g., a utility power source) (not shown) by plural electrical conductors 14 (shown in FIG. 3). The marina power pedestal 2 also includes a number of output power receptacles 16 (shown in FIGS. 3 and 4) mounted to the enclosure 10.

In some example embodiments of the disclosed concept, the marina power pedestal 2 further includes a number of circuit interrupters, such as, for example and without limitation, circuit breakers 18 having a ground fault circuit interruption capability (shown in FIG. 4). In some other example embodiments of the disclosed concept, the marina power pedestal 2 does not include a ground fault circuit interruption capability.

The marina power pedestal 2 is structured to be attached to the platform 8 in the vicinity of water 3. The marina power pedestal 2 further includes a stray current detection unit that is structured to detect a stray current in the water 3. The stray current detection unit includes a stray current probe 60 and a stray current detection circuit 63 (shown in FIG. 2).

The stray current probe 60 is structured to extend from the enclosure 10 and into the water. The stray current probe 60 includes a cord 61 and a voltage sensor 62. The cord 61 electrically connects the voltage sensor 62 to the stray current detection circuit 63. The voltage sensor 62 is structured to submerge in the water 3 and sense a voltage in the water.

The stray current detection circuit 63 is electrically connected to the stray current probe 60 and is structured to detect a stray current based on the voltage sensed by the stray current probe 60. In some example embodiments of the disclosed concept, the stray current detection circuit 63 is structured to compare the voltage sensed by the stray current probe 60 to a predetermined threshold voltage. When the voltage sensed by the stray current probe 60 exceeds the predetermined threshold voltage, the stray current detection circuit 63 detects the stray current in the water 3. In response to detecting the stray current, the stray current detection circuit 63 outputs an indicator signal to an indicator 52 included in the marina power pedestal 2.

The indicator 52 is structured to provide an indication in response to the indicator signal. In some example embodiments of the disclosed concept, the indication is a visual indication and the indicator 52 may be a light source such as, for example and without limitation, a light emitting diode (LED). In some other example embodiments of the disclosed concept, the indicator 52 may provide an audible indication such as a sound. The indication is observable from outside the enclosure 10 so that people can be made aware of a stray current condition in the water 3 around the marina power pedestal 2.

Referring to FIG. 3, the input power terminals 12 of the marina power pedestal 2 of FIG. 1 are shown. These terminals 12 include a first line terminal 32 (LINE1), a second line terminal 34 (LINE2), a neutral terminal 36 and a ground terminal 38. As shown by the two example electrical conductors 14, the terminals 32,34,36,38 are structured to be electrically connected to a suitable power source (not shown) by those conductors, which extend through the opening 40. It will be appreciated that the other terminals 34,38 may also be electrically connected to the power source by other electrical conductors (not shown). The other electrical conductors 42 are electrically connected to the circuit breakers 18 and the output power receptacles 16.

Referring to FIG. 4 a schematic diagram of a ground fault protection circuit is shown. The ground fault protection circuit includes the input power terminals 12, the output power receptacles 16 and the circuit breakers 18 with ground fault capability. In example embodiments of the disclosed concept where the marina power pedestal 2 does not provide ground fault protection, the circuit breakers 18 with ground fault protection are omitted. In some example embodiments of the disclosed concept, the circuit breakers 18 with ground fault protection may be replaced with circuit breakers without ground fault protection.

Stray currents are an issue associated with marina power pedestals that do not include ground fault protection. The disclosed concept is particularly applicable to marina power pedestals that do not include ground fault protection. However, the disclosed concept may also be applied to marina power pedestals that include ground fault protection. The stray current detection unit allows for detection of stray currents in the case that the ground fault protection in the marina power pedestal has failed. Additional, the stray current detection circuit may detect stray currents that were caused by other marina power pedestals in the area.

As previously described, the input power terminals 12 are mounted to the pedestal member 4 and are structured to be electrically connected to a power source (e.g., a utility power source) (not shown). The input power terminals 12 are electrically connected to the output power receptacles 16. In more detail, NEUTRAL and GROUND electrical connections of the input power terminals 12 are electrically connected to the output power receptacles 16 and LINE1 and LINE2 electrical connections of the input power terminals 12 are electrically connected to the output power receptacles 16 via the circuit breakers 18. The circuit breakers 18 have the capability of detecting a ground fault on the power circuit. When one of the circuit breakers 18 detects a ground fault, it trips open, electrically disconnecting the corresponding output power receptacle from LINE1 or LINE2.

FIG. 5 is a cross-sectional view of an upper housing 55 (shown in FIG. 1) of the power pedestal 2 in accordance with an example embodiment of the disclosed concept. In the example embodiment of FIG. 5, the indicator 52 is a light source such as, without limitation, an LED. FIG. 5 shows the area inside the power pedestal 2 where the indicator 52 is located. Since the indicator 52 is located in a top portion of the power pedestal 2, it is easy to see when it is illuminated. Also, the upper housing 55 of the power pedestal 2 includes transparent or translucent exterior panels so that light from the indicator 52 can be seen from outside the power pedestal 2.

In some example embodiments of the disclosed concept, the power pedestal 2 further includes a photocell 54. The photocell 54 provides ambient light detection which can be used to turn off lights on the power pedestal 2 when it is light outside in order to save power.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A power pedestal structured to be attached to a platform in the vicinity of water, the power pedestal comprising:
a pedestal member comprising:
a base structured to be attached to the platform, and
an enclosure extending from said base;
a stray current detection unit comprising:
a stray current probe structured to extend outside the enclosure and into the water to sense a voltage in the water, and
a stray current detection circuit electrically connected to the stray current probe and structured to detect a stray current in the water based on the voltage sensed by the stray current probe and to output an indicator signal in response to detecting the stray current; and
an indicator electrically coupled to the stray current detection unit and structured to provide an indication in response to the indicator signal.

2. The power pedestal of claim 1, wherein the stray current probe comprises:
a voltage sensor structured to sense the voltage in the water; and
a cord structured to electrically connect the voltage sensor to the stray current detection circuit.

3. The power pedestal of claim 1, wherein the stray detection circuit is structured to compare the voltage sensed by the stray current probe to a predetermined threshold voltage and to detect the stray current in the water when the voltage sensed by the stray current probe exceeds the predetermined threshold voltage.

4. The power pedestal of claim 1, wherein the indicator is structured to provide a visual indication in response to the indicator signal.

5. The power pedestal of claim 4, wherein the indicator is a light.

6. The power pedestal of claim 5, wherein the indicator is a light emitting diode.

7. The power pedestal of claim 1, wherein the indicator is structured to provide an audible indication in response to the indicator signal.

8. The power pedestal of claim 1, further comprising:
a plurality of input power terminals mounted to said pedestal member and structured to be electrically connected to a power source; and
a number of output power receptacles mounted to said enclosure.

9. The power pedestal of claim 8, wherein the input power terminals include a first line terminal, a second line terminal, a neutral terminal, and a ground terminal.

10. The power pedestal of claim 1, further comprising:
a number of circuit interrupters having a ground fault detection capability.

11. The power pedestal of claim 1, wherein the power pedestal does not have a ground fault detection capability.

12. The power pedestal of claim 1, wherein the indicator is disposed in an upper housing of the power pedestal.

13. The power pedestal of claim 12, wherein the upper housing includes transparent or translucent panels.
